(19) United States
(12) Patent Application Publication
(10) Pub. No.: US 2025/0050888 A1
(43) Pub. Date: Feb. 13, 2025

(54) APPARATUS AND METHOD FOR CONTROLLING LANE CHANGE

(71) Applicants: Hyundai Motor Company, Seoul (KR); Kia Corporation, Seoul (KR)

(72) Inventors: Sung Kwan KIM, Incheon (KR); Su Jin HAN, Seoul (KR)

(73) Assignees: Hyundai Motor Company, Seoul (KR); Kia Corporation, Seoul (KR)

(21) Appl. No.: 18/510,529

(22) Filed: Nov. 15, 2023

(30) Foreign Application Priority Data
Aug. 7, 2023 (KR) 10-2023-0103007

(51) Int. Cl. B60W 30/18

(52) U.S. Cl. CPC B60W 30/18163; B60W 2520/06; B60W 2520/10; B60W 2552/10

(57) ABSTRACT

A lane change control apparatus includes a processor configured to generate a second lane change path according to a head angle of a vehicle at a current position of the vehicle to try lane change again in response to a case where the lane change is canceled while the vehicle is performing the lane change according to a first lane change path and then the cancellation of the lane change is withdrawn while the vehicle is returning to an original lane of the vehicle; and a storage configured to store data and algorithms driven by the processor.

### CROSS-REFERENCE TO RELATED APPLICATION

The present application claims priority to Korean Patent Application No. 10-2023-0103007, filed on Aug. 7, 2023, the entire contents of which is incorporated herein for all purposes by this reference.

### BACKGROUND OF THE PRESENT DISCLOSURE

### Field of the Present Disclosure

The present disclosure relates to a lane change control apparatus and a method thereof, and more particularly, to a technique for rapid response control in response to a case where cancellation of a lane change is withdrawn.

### Description of Related Art

Recently, with rapid development of IT technology, an interest in intelligent vehicles converged with vision systems is increasing. Cutting-edge safety vehicle technology such as lane departure information, lane keeping, collision warning system, and lane change control system that reduce a risk of traffic accidents and help safe driving is a basic technology of intelligent vehicle technology, and a lot of manpower and financial resources are being invested in various research and technology development.

A lane change control system capable of automatically changing a lane in which a vehicle is driving automatically controls the vehicle to perform a lane change in response to a case where a driver operates a turn signal with intention of changing a lane.

Such a lane change control system may perform a lane change by determining whether speeds and positions of surrounding vehicles are suitable for performing the lane change, setting a control path for the lane change, and controlling steering torque along the control path.

However, the lane change may be canceled in response to a case where an object behind a target lane, which is a target of the lane change, approaches rapidly in performing the lane change. Accordingly, even if it changes to a situation in which the lane change is possible, such as the speed of objects behind the target lane being reduced, after canceling the lane change, conventionally, after the vehicle completely returns to an original lane, the lane change may be attempted again.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a lane change control apparatus and a method thereof, configured for rapidly and reliably retrying a lane change in consideration of a degree of turning of a vehicle from a current position of the vehicle without the vehicle returning completely to an original lane in response to a case where cancellation of the lane change is withdrawn.

An exemplary embodiment of the present disclosure attempts to provide a lane change control apparatus and a method thereof, configured for minimizing a sense of difference in lane change and ensuring smooth vehicle behavior by generating a new lane change path by reflecting a degree of turning of a vehicle using a function in response to a case where cancellation of the lane change is withdrawn.

The technical objects of the present disclosure are not limited to the objects mentioned above, and other technical objects not mentioned may be clearly understood by those skilled in the art from the description of the claims.

An exemplary embodiment of the present disclosure provides a lane change control apparatus including: a processor configured to generate a second lane change path according to a head angle of a vehicle at a current position of the vehicle to try lane change again in response to a case where the lane change is canceled while the vehicle is performing the lane change according to a first lane change path and then the cancellation of the lane change is withdrawn while the vehicle is returning to an original lane of the vehicle; and a storage configured to store data and algorithms driven by the processor.

In an exemplary embodiment of the present disclosure, the processor may be configured, for generation of the second lane change path, to generate a lane change reference line as a reference for the vehicle to perform the lane change, and to generate a driving direction reference line extending in a driving direction of the vehicle.

In an exemplary embodiment of the present disclosure, the processor may be configured to generate the lane change reference line as a straight line extending from a front center portion of the vehicle, to allow the lane change reference line to be in parallel to a central line of a driving lane in which the vehicle is driving.

In an exemplary embodiment of the present disclosure, the processor may be configured to determine an angle between the lane change reference line and the driving direction reference line.

In an exemplary embodiment of the present disclosure, the processor may be configured to correct the lane change reference line according to a head angle of the vehicle.

In an exemplary embodiment of the present disclosure, the processor may be configured to move the lane change reference line in a direction of a target lane, which is a target for the lane change, or in a direction of a driving lane in which the vehicle is currently driving by use of an angle between the lane change reference line and the driving direction reference line.

In an exemplary embodiment of the present disclosure, the processor may be configured to determine a movement amount of the lane change reference line using at least one of a distance from the central line of the driving lane to the lane change reference line, an angle between the lane change reference line and the driving direction reference line, or a combination thereof.

In an exemplary embodiment of the present disclosure, the processor may be configured to determine a movement amount of the lane change reference line by applying an angle between the lane change reference line and the driving direction reference line to a function.

In an exemplary embodiment of the present disclosure, the processor may be configured, in response to a case of moving the lane change reference line in a direction of the target lane, to prevent the lane change reference line from encroaching on a lane next to the target lane.

In an exemplary embodiment of the present disclosure, the processor may be configured, in response to a case of moving the lane change reference line in a direction of the driving lane, to prevent the lane change reference line from encroaching on a central line of the driving lane.

In an exemplary embodiment of the present disclosure, the processor may be configured to determine a lane change start point, which is a start point for the lane change by use of at least one of a speed of the vehicle, a control target time, an angle between the lane change reference line and the driving direction reference line, or a combination thereof.

In an exemplary embodiment of the present disclosure, the processor may be configured to determine a lane change start point by applying an angle between the lane change reference line and the driving direction reference line to a function.

In an exemplary embodiment of the present disclosure, the processor may be configured to determine the lane change start point to be positioned on the moved lane change reference line.

In an exemplary embodiment of the present disclosure, the processor may be configured to determine a lane change end point, which is a point at which the lane change is completed, by use of a speed of the vehicle and a time required for the lane change to be completed from the lane change start point.

In an exemplary embodiment of the present disclosure, the processor may be configured to determine a lane change intermediate point between the lane change start point and the lane change end point according to a distance ratio predetermined by a user.

In an exemplary embodiment of the present disclosure, the processor may be configured to increase a movement amount of the lane change reference line, and to increase a driving distance for the lane change as an angle between the lane change reference line and the driving direction reference line increases.

In an exemplary embodiment of the present disclosure, the processor may be configured, in response to a case where the vehicle follows a return path to the original lane and returns to the original vehicle, the return path including a start point, an intermediate point, and an end point, in a state where cancellation of the lane change is withdrawn at the start point and a head of the vehicle is directed in a direction of a target lane, which is a target for the lane change, to move the lane change reference line in the direction of the target lane.

In an exemplary embodiment of the present disclosure, the processor may be configured, in response to a case where the vehicle follows a return path to the original lane and returns to the original vehicle, the return path including a start point, an intermediate point, and an end point, in a state where cancellation of the lane change is withdrawn at the intermediate point and a head of the vehicle is directed in the direction of the original lane, to move the lane change reference line in the direction of the original lane.

An exemplary embodiment of the present disclosure provides a lane change control method including: canceling, by a processor, a lane change while a vehicle is performing the lane change along a first lane change path; withdrawing, by the processor, cancellation of the lane change while the vehicle is returning to an original lane of the vehicle; and generating, by the processor, a second lane change path according to a head angle of the vehicle from a current position of the vehicle to attempt the lane change again.

In an exemplary embodiment of the present disclosure, the generating of the second lane change path may include: generating, by the processor, a lane change reference line as a reference for the vehicle to perform the lane change, and generating a driving direction reference line extending in a driving direction of the vehicle, for generation of the second lane change path; and moving the lane change reference line in a direction of a target lane, which is a target for the lane change, or in a direction of a driving lane in which the vehicle is currently driving by use of an angle between the lane change reference line and the driving direction reference line.

According to the present technique, it is possible to rapidly and reliably retry a lane change in consideration of a degree of turning of a vehicle from a current position of the vehicle without the vehicle returning completely to an original lane in response to a case where cancellation of the lane change is withdrawn, shortening a time to perform the lane change.

According to the present technique, it is possible to minimize a sense of difference in lane change and ensure smooth vehicle behavior by generating a new lane change path by reflecting a degree of turning of a vehicle using a trigonometric function in response to a case where cancellation of the lane change is withdrawn.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing an example configuration of a vehicle system including a lane change control apparatus.

FIG. 2A illustrates an example of generating a lane change path.

FIG. 2B illustrates an example of a case of performing a lane change.

FIG. 2C illustrates an example of generating a lane change cancellation path.

FIG. 2D illustrates an example of generating a new lane change path in response to a case where lane change cancellation is withdrawn.

FIG. 3A illustrates an example view for describing a lane change cancellation step.

FIG. 3B illustrates an example view for describing a step of generating a new lane change path after canceling the lane change.

FIG. 4A illustrates an example view for describing an initial step of canceling a lane change.

FIG. 4B illustrates an example view for describing a step of generating a new lane change path in an initial step of canceling the lane change.

FIG. 5A illustrates an example view for describing an intermediate step of canceling a lane change.

FIG. 5B illustrates an example view for describing a step of generating a new lane change path in an intermediate step of canceling the lane change.

FIG. 6 illustrates a flowchart showing an example lane change control method.

FIG. 7 illustrates an example computing system.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements include the same reference numerals as possible even though they are indicated on different drawings. In describing an exemplary embodiment of the present disclosure, when it is determined that a detailed description of the well-known configuration or function associated with the exemplary embodiment of the present disclosure may obscure the gist of the present disclosure, it will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field of the present disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

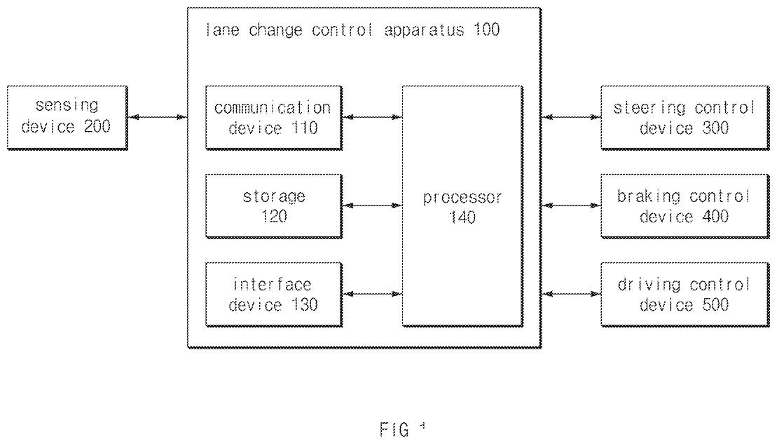

Hereinafter, various exemplary embodiments of the present disclosure will be described in detail with reference to FIG. 1 to FIG. 7.

FIG. 1 illustrates a block diagram showing an example configuration of a vehicle system including a lane change control apparatus.

Referring to FIG. 1, the vehicle system according to an exemplary embodiment of the present disclosure may include a lane change control apparatus 100, a sensing device 200, a steering control device 300, a braking control device 400, and a driving control device 500.

According to an exemplary embodiment of the present disclosure, the lane change control apparatus 100 may be implemented within or separately from a vehicle. In the instant case, the lane change control apparatus 100 may be integrally formed with internal control units of the vehicle, or may be implemented as a separate hardware device to be connected to control units of the vehicle by a connection means. For example, the lane change control apparatus 100 may be implemented integrally with the vehicle, may be implemented in a form which is installed or attached to the vehicle as a configuration separate from the vehicle, or a part thereof may be implemented integrally with the vehicle, and another part may be implemented in a form which is installed or attached to the vehicle as a configuration separate from the vehicle.

In response to a case where a lane change is canceled while the vehicle is changing lanes according to a lane change path and the cancellation of the lane change is withdrawn while the vehicle is returning to an original lane, the lane change control apparatus 100 may be configured to generate a new lane change path for retrying the lane change according to a head angle of the vehicle at a current position of the vehicle to try the lane change again.

To the present end, the lane change control apparatus 100 may include a communication device 110, a storage 120, an interface device 130, and a processor 140.

The communication device 110 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include Controller Area Network (CAN) communication, Local Interconnect Network (LIN) communication, flex-ray communication, and the like.

Furthermore, the communication device 110 may perform communication with a server, infrastructure, or third vehicles outside the vehicle, and the like through a wireless Internet access or short range communication technique. Herein, the wireless communication technique may include wireless LAN (WLAN), Wireless Broadband (WiBro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like.

The communication device 110 may perform Vehicle-To-Everything (V2X) communication. The Vehicle-To-Everything (V2X) communication may include communication between vehicle and all entities such as vehicle-to-vehicle (V2V) communication which refers to communication between vehicles, Vehicle-To-Infrastructure (V21) communication which refers to communication between a vehicle and an eNB or road side unit (RSU), Vehicle-To-Pedestrian (V2P) communication, which refers to communication between user equipment (UE) held by vehicles and individuals (pedestrians, cyclists, vehicle drivers, or occupants), and Vehicle-To-Network (V2N) communication.

As an exemplary embodiment of the present disclosure, the communication device 110 may receive a sensing result from the sensing device 200, and may transmit command signals to the steering control device 300, the braking control device 400, and the drive control device 500.

The storage 120 may store sensing results of the sensing device 200 and data and/or algorithms required for the processor 140 to operate, and the like.

As an exemplary embodiment of the present disclosure, the storage 120 may store an algorithm for determining a lane change condition, a lane change cancellation condition, a lane change cancellation withdrawal condition, and the like, an algorithm for the lane change, an algorithm for generating a lane change path, etc.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. The interface device 130 may be implemented as a head-up display (HUD), a cluster, an audio video navigation (AVN), or a human machine interface (HM), a human machine interface (HMI).

The input means may include a key button, and may include a mouse, a joystick, a jog shuttle, a stylus pen, and the like. Furthermore, the input means may include a soft key implemented on the display.

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In an exemplary embodiment of the present disclosure, the output device may output platooning information such as sensor failure information, lead vehicle information, group rank information, a platooning speed, a destination, a waypoint, a path, and the like.

In the instant case, the display may include at least one of a liquid crystal display (LCD), a thin film transistor liquid crystal display (TFT LCD), an organic light emitting diode display (OLED display), a flexible display, a field emission display (FED), a 3D display, or any combination thereof.

The processor 140 may be electrically connected to the communication device 110, the storage 120, the interface device 130, and the like, may electrically control each component, and may be an electrical circuit that executes software commands, performing various data processing and determinations described below.

The processor 140 may be configured to process a signal transferred between components of the lane change control apparatus 100 to perform overall control so that each of the components can perform its function normally. The processor 140 may be implemented in a form of hardware, software, or a combination of hardware and software. For example, the processor 140 may be implemented as a microprocessor, but the present disclosure is not limited thereto. For example, it may be, e.g., an electronic control unit (ECU), a micro controller unit (MCU), or other subcontrollers mounted in the vehicle.

In response to a case where a lane change is canceled while the vehicle is changing lanes according to a lane change path and the cancellation of the lane change is withdrawn while the vehicle is returning to an original lane, the processor 140 may be configured to generate a new lane change path according to a head angle of the vehicle at a current position of the vehicle to try the lane change again.

The processor 140 may be configured to generate a lane change reference line, which is a reference for a vehicle to change a lane, to generate a new lane change path for retrying the lane change, and may be configured to generate a driving direction reference line extending in a driving direction of the vehicle.

The processor 140 may be configured to generate a lane change reference line as a straight line extending from a center portion of the front of the vehicle, and in the instant case, may be configured to generate the lane change reference line in parallel to a central line of a driving lane (original lane) in which the vehicle is driving. The processor 140 may correct the lane change reference line according to the head angle of the vehicle.

The processor 140 may be configured to determine an angle between the lane change reference line and the driving direction reference line, and may move the lane change reference line in a direction of a target lane, which is a target for lane change, or in a direction of a driving lane in which the vehicle is currently driving by use of the angle between the lane change reference line and the driving direction reference line.

The processor 140 may be configured to determine a movement amount of the lane change reference line using at least one of a distance from a central line of the driving lane to the lane change reference line, the angle between the lane change reference line and the driving direction reference line, or a combination thereof.

The processor 140 may be configured to determine the movement amount of the lane change reference line by applying the angle between the lane change reference line and the driving direction reference line to a trigonometric function, but may use an increasing function for the angle between the lane change reference line and the driving direction reference line instead of the trigonometric function.

The processor 140 prevents the lane change reference line from encroaching on a next lane of the target lane in response to moving the lane change reference line in a direction of the target lane, and may be configured to determine not to encroach on a central line of the driving lane in response to moving the lane change reference line in the direction of the driving lane.

The processor 140 may be configured to determine a lane change start point, which is a start point for lane change by use of at least one of a vehicle speed, a control target time, the angle between the lane change reference line and the driving direction reference line, or a combination thereof. That is, the lane change start point indicates a start point of the lane change path.

The processor 140 is configured to determine the lane change start point by applying the angle between the lane change reference line and the driving direction reference line to a trigonometric function, and may be configured to determine the lane change start point to be positioned on the moved (corrected) lane change reference line.

The processor 140 may be configured to determine a lane change end point, which is a point at which the lane change is completed, by use of a vehicle speed and a time required for the lane change to be completed from the lane change start point.

The processor 140 may be configured to determine a lane change intermediate point between the lane change start point and the lane change end point according to a distance ratio predetermined by a user. Accordingly, the lane change start point, the lane change intermediate point, and the lane change end point may be connected in a straight line to be generated as a lane change path.

As the angle between the lane change reference line and the driving direction reference line increases, a movement amount of the lane change reference line may increase, and the driving distance for lane change may increase.

In response to a case where the vehicle follows a return path to an original lane including a start point, an intermediate point, and an end point and returns to the original lane, the processor 140 may move the lane change reference line in a direction of a target lane in a state where the cancellation of the lane change is withdrawn from the start point and a head of the vehicle is facing in the direction of the target lane which is a target of the lane change.

Furthermore, the processor 140 may move the lane change reference line in a direction of the original lane in response to a case where the cancellation of the lane change is withdrawn at the intermediate point of the return path to the original lane and the head of the vehicle is facing in the direction of the original lane.

The sensing device 200 may include one or more sensors that sense an obstacle, e.g., a preceding vehicle, positioned around the host vehicle and measure a distance with the obstacle and/or a relative speed thereof.

The sensing device 200 may include a plurality of sensors to detect an external object of the vehicle, to obtain information related to a position of the external object, a speed of the external object, a moving direction of the external object, and/or a type of the external object (e.g., vehicles, pedestrians, bicycles or motorcycles, etc.). The sensing device 200 may detect an object driving in a target lane for lane change, and may detect a position, a speed, a movement direction, and the like of the object driving in the target lane. To the present end, the sensing device 200 may include an ultrasonic sensor, a radio detection and ranging (RADAR), a camera, a laser scanner, and/or a corner radar, a Light Detection and Ranging (LiDAR), an acceleration sensor, a yaw rate sensor, a torque measurement sensor and/or a wheel speed sensor, a steering angle sensor, etc.

A steering control device 300 may be configured to control a steering angle of a vehicle, and may include a steering wheel, an actuator interlocked with the steering wheel, and a controller configured for controlling the actuator.

The braking control device 400 may be configured to control braking of the vehicle, and may include a controller that is configured to control a brake thereof.

The driving control device 500 may be configured to control engine or motor driving of a vehicle, and may include a controller that is configured to control a speed of the vehicle.

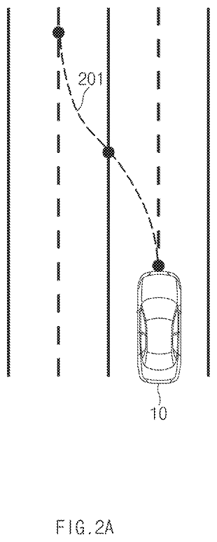

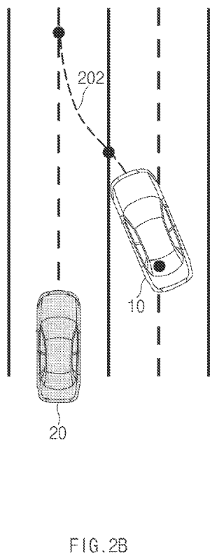

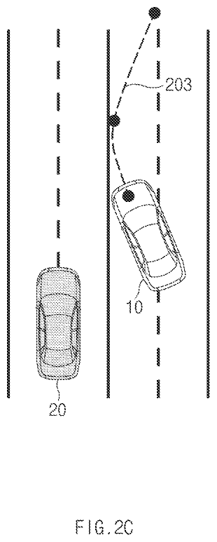

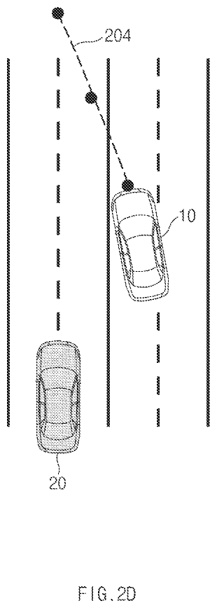

FIG. 2A illustrates an example of generating a lane change path, and FIG. 2B illustrates an example of a case of performing a lane change. FIG. 2C illustrates an example of generating a lane change cancellation path, and FIG. 2D illustrates an example of generating a new lane change path in response to a case where lane change cancellation is withdrawn.

Referring to FIG. 2A, in response to a case where a lane change is required while the vehicle is driving, the lane change control apparatus 100 may be configured to generate a lane change path 201 to attempt the lane change to a target lane.

Referring to FIG. 2B, the lane change control apparatus 100 may cancel the lane change in response to a case where a rear object 20 is driving at a predetermined speed (e.g., a relative speed) or more to rear of the target lane to which the vehicle 10 is to change lanes or enters within a distance set by a user (e.g., within 10 meters from rear of a center portion of the vehicle 10) while the vehicle 10 performs the lane change to along a lane change path 202.

Referring to FIG. 2C, the lane change control apparatus 100 generates a return path 203 for the vehicle 10 to return to the original path after canceling the lane change, and is configured to control the vehicle 10 to return to the original path.

However, the lane change control apparatus 100 may withdraw the cancellation of the lane change in response to a case where a speed of a rear object of the target lane to be changed is rapidly decelerating below a predetermined reference speed, it moves away beyond a distance predetermined by a user, or the rear object is misrecognized.

Referring to FIG. 2D, the lane change control apparatus 100 may generates a new lane change path 204 for a new lane change while returning to the original lane and is configured to perform the lane change again.

Accordingly, according to an exemplary embodiment of the present disclosure, even in a state where the vehicle 10 does not completely return to the original lane upon withdrawal of lane change cancellation, it is possible to rapidly respond to a change in behavior of the rear object 20 of the target lane, which is a cause of the lane change cancellation by generating the new lane change path 204 from a current position of the vehicle 10, and it is possible to increase lane change efficiency and user satisfaction by allowing the lane change to be immediately performed again without returning to the original path.

Furthermore, upon withdrawal of lane change cancellation, the new lane change path 204 may be generated by checking a head angle of the vehicle 10 and reflecting a degree of turning of the vehicle 10, minimizing a sense of difference due to a steering change.

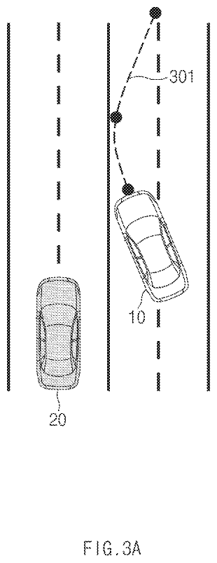

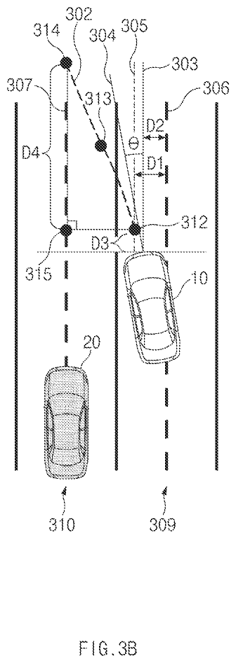

FIG. 3A illustrates an example view for describing a step of canceling a lane change, and FIG. 3B illustrates an example view for describing a step of generating a new lane change path after canceling the lane change.

Referring to FIG. 3A, the lane change control apparatus 100 is configured to control the vehicle 10 to return to an original lane 309 along a return path 301 to the original lane 309 in response to a case where the lane change is canceled because a speed of an object 20 behind a target lane 310 increases while the vehicle 10 attempts to perform the lane change.

Referring to FIG. 3B, in response to a case where a speed of the object 20 behind the target lane 310 is rapidly reduced, the lane change control apparatus 100 withdraws the lane change cancellation and is configured to determine an angle of turning of the vehicle 10, and generates a new lane change path 302 by reflecting the angle of turning of the vehicle 10.

A process of generating the new lane change path 302 in detail will be described below.

The lane change control apparatus 100 generates a lane change reference line 303 for lane change. In the instant case, the lane change control apparatus 100 may be parallel to a lane center line 306 of a driving lane, and the lane center line 306 of a driving lane may be positioned on an extension from the front of the vehicle 10 (e.g., a center portion of a buffer).

Subsequently, the lane change control apparatus 100 generates a driving direction reference line 304 in a driving direction of the vehicle 10. The driving direction of the vehicle 10 is the same as a head angle direction of the vehicle 10.

The lane change control apparatus 100 is configured to determine an angle θ between the lane change reference line 303 and the driving direction reference line 304. In the instant case, the angle θ between the lane change reference line 303 and the driving direction reference line 304 indicates the angle of turning of the vehicle 10.

The lane change control apparatus 100 generates a moved lane change reference line 305 by moving the lane change reference line 303 by reflecting the angle θ between the lane change reference line 303 and the driving direction reference line 304.

In the instant case, a distance D1 from the lane center line 306 of the driving lane to the moved lane change reference line 305 becomes a movement amount of the lane change reference line 303.

$$D 1 = D 2 * ( 1 + sin ( θ ) ) \qquad ( Equation 1 )$$

D1 indicates a distance from the lane center line 306 of the driving lane to the moved lane change reference line 305, and D2 indicates a distance from the lane center line 306 of the driving lane (original lane 309) to a center portion of a host vehicle, that is, a distance to the lane change reference line 303.

The moved lane change reference line 305 may not cross the center line 306 of the driving lane in a state where the moved lane change reference line 305 moves in the direction of the driving lane (original lane 309), and the moved lane change reference line 305 may not cross a line of the target lane in a state where the moved lane change reference line 305 is moved in a direction of the target lane 310. This is because an opposite lane may be invaded in a state where the moved lane change reference line 305 crosses the center line 306 of the driving lane or crosses the lane of the target lane 310.

As described above, in response to generation of the moved lane change reference line 305, the lane change control apparatus 100 may be configured to determine a lane change start point, which is a point at which a lane change starts, to generate a lane change path.

That is, the lane change control apparatus 100 may be configured to determine a lane change start point 312 through Equation 2 below.

$$D 3 = V * K * ( 1 + \vert sin θ \vert ) \qquad ( Equation 2 )$$

D3 indicates a vertical distance from the front (e.g., bumper) of the host vehicle to the lane change starting point 312. In the instant case, the lane change start point 312 may be positioned on the moved lane change reference line 305.

V indicates a speed of the host vehicle, and K may be set to, e.g., 0.65 as a control target time (tuning parameter) and may be determined in advance by an experimental value.

Herein, a sin function may be replaced with an increasing function for θ whose value may increase as θ increases.

In a state where the lane change start point 312 is determined in the present way, a lane change end point 314 may be determined to generate a lane change path. The lane change end point 314 indicates a point at which the lane change is completed in a state where the lane change is performed for a predetermined time period (e.g., 6 seconds) in a longitudinal direction from the lane change start point 312.

To the present end, the lane change control apparatus 100 is configured to determine the distance D4 to the lane change end point 314 from a point 315 at which a perpendicular line which is drawn from the lane change start point 312 to a central line 307 of the target lane 310 meets the central line 307 as illustrated in Equation 3 below.

$$D 4 = V * L \qquad ( Equation 3 )$$

V indicates the speed of the host vehicle, and L indicates a time required for the vehicle to reach the lane change end point 314 (e.g., 6 seconds).

In the instant case, the lane change end point 314 may be positioned on the central line 307 of the target lane 310, and a length obtained by drawing a straight line from the lane change start point 312 to the lane change end point 314 is equal to D4.

As in Equation 3, in response to a case where the vehicle travels at a current speed and reaches the central line 307 of the target lane while moving as much as the distance D4 in case of changing lanes for L time, the reached position is the lane change end point 314.

Accordingly, in response to a case where the lane change end point 314 is determined, the lane change control apparatus 100 may be configured to determine a lane change intermediate point 313.

The lane change control apparatus 100 may be configured to determine the lane change intermediate point 313 at a ratio set by a user. For example, in response to a case where the user sets a distance from the lane change start point 312 to the lane change intermediate point 313 and the distance from the lane change midpoint 313 to the lane change end point 314 as 1:1, and the lane change intermediate point 313 may be determined as an intermediate point between the lane change start point 312 and the lane change end point 314.

As described above, according to an exemplary embodiment of the present disclosure, in response to a case where the cancellation of the lane change is withdrawn, the difference in steering may be minimized by generating a new lane change path by reflecting a current degree of turning of the vehicle.

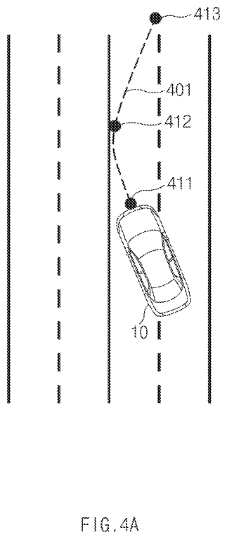

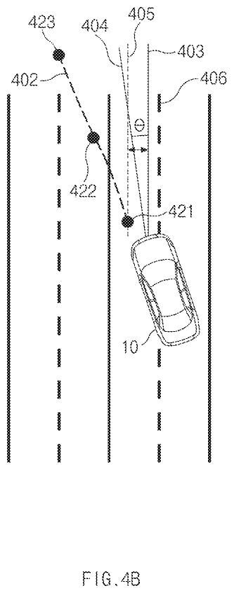

FIG. 4A illustrates an example view for describing an initial step of canceling a lane change, and FIG. 4B illustrates an example view for describing a step of generating a new lane change path in an initial step of canceling the lane change.

Referring to FIG. 4A, when a lane change is canceled, the lane change control apparatus 100 is configured to control the vehicle 10 to return to an original lane along a return path 401 to the original lane. In the instant case, the return path 401 includes a start point 411, an intermediate point 412, and an end point 413, and the vehicle 10 starts from the start point 411 and moves to the end point 413 via the intermediate point 412.

In response to a case where the cancellation of the lane change is withdrawn while the vehicle 10 is positioned at the start point 411, as illustrated in FIG. 4B, the lane change control apparatus 100 generates a lane change reference line 403 by moving a central line 406 of a driving lane to the front of the vehicle 10, is configured to determine an angle between a driving direction reference line 404 and the lane change reference line 403, and is configured to determine a movement amount of the lane change reference line 403 to generate the moved lane change reference line 405.

Subsequently, the lane change control apparatus 100 may be configured to determine a lane change start point 421 on the moved lane change reference line 405, and may sequentially determine a lane change end point 423 and a lane change intermediate point 422 to generate a new lane change path 402.

In the instant case, the lane change reference line 405 moved with a head angle of the vehicle 10 turned toward the target lane is generated closer to the target lane than the driving lane, and thus a smooth lane change may be achieved by allowing the vehicle 10 to move toward the target lane.

In the instant case, as the turned angle of the vehicle 10 increases, the lane change reference line 403 provided as a reference for the lane change may be moved more, and a length of the lane change path may be further increased, achieving a smooth lane change.

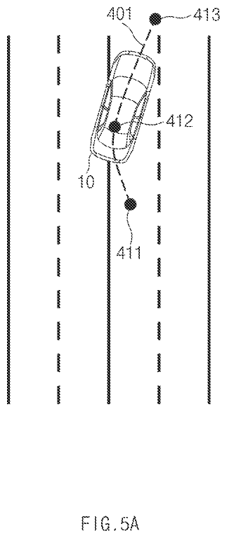

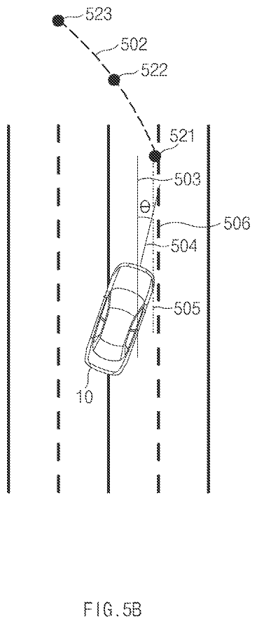

FIG. 5A illustrates an example view for describing an intermediate step of canceling a lane change, and FIG. 5B illustrates an example view for describing a step of generating a new lane change path in an intermediate step of canceling the lane change.

Referring to FIG. 5A, when a lane change is canceled, the lane change control apparatus 100 is configured to control the vehicle 10 to return to an original lane along a return path 401 to the original lane. In the instant case, the return path 401 includes a start point 411, an intermediate point 412, and an end point 413, and the vehicle 10 starts from the start point 411 and moves to the end point 413 via the intermediate point 412.

In FIG. 5A, in response to a case where the cancellation of the lane change is withdrawn while the vehicle 10 is positioned at the intermediate point 412, as illustrated in FIG. 5B, the lane change control apparatus 100 generates a lane change reference line 503 by moving a central line 506 of a driving lane to the front of the vehicle 10, is configured to determine an angle between a driving direction reference line 504 and the lane change reference line 503, and is configured to determine a movement amount of the lane change reference line 503 to generate the moved lane change reference line 505. In the instant case, a moved lane change reference line 505 is generated so as not to go beyond the central line 506 of the driving lane (original lane).

Subsequently, the lane change control apparatus 100 may be configured to determine a lane change start point 521 on the moved lane change reference line 505, and may sequentially determine a lane change end point 523 and a lane change intermediate point 522 to generate a new lane change path 502.

In the instant case, the lane change reference line 505 moved with the head angle of the vehicle 10 turned toward the driving lane is generated closer to the driving lane (original lane) than to the target lane, and thus a smooth lane change may be achieved by allowing the vehicle 10 to move toward the driving lane (original lane).

Accordingly, it may be seen in FIG. 5B that the lane change start point 521 is determined farther from the vehicle 10 than in FIG. 4B. As an angle between the driving direction reference line 504 and the lane change reference line 503 increases, the lane change start point 521 moves away from the vehicle to reduce the difference of steering, and as the lane change start point 521 is farther away from the vehicle, the lane change end point 523 is also further away from the vehicle 10, so a total driving distance for the lane change becomes longer. Accordingly, as the total mileage for changing lanes becomes longer, it may be possible to smoothly change lanes.

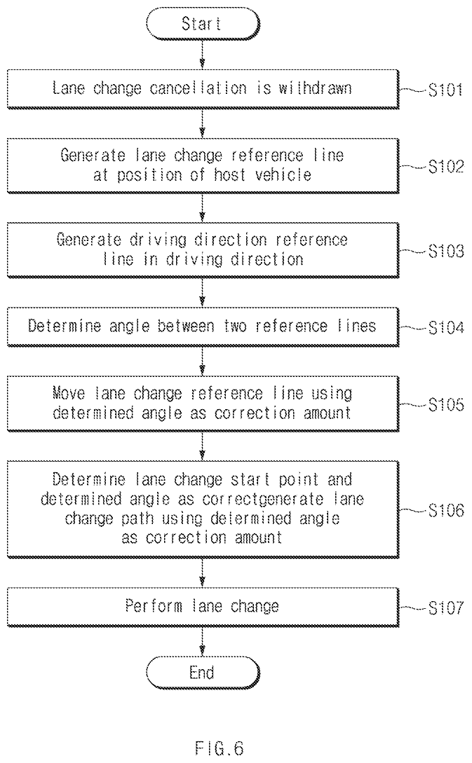

Hereinafter, a lane change control method according to an exemplary embodiment of the present disclosure will be described with reference to FIG. 6. FIG. 6 illustrates a flowchart showing an example lane change control method.

Hereinafter, it is assumed that the lane change control apparatus 100 of the of FIG. 1 is configured to perform processes of FIG. 6. Furthermore, in the description of FIG. 6, operations described as being performed by a device may be understood as being controlled by the processor 140 of the lane change control apparatus 100. However, to help the understanding of the description, FIG. 3B will be referred to together.

Referring to FIG. 6 and FIG. 3B, in response to a case where the lane change is canceled during the lane change to the target lane 310 and the cancellation of the lane change is withdrawn (S101), the lane change control apparatus 100 generates the lane change reference line 303 at a current position of the vehicle 10 (host vehicle) to attempt the lane change again (S102).

That is, the lane change control apparatus 100 may be configured to generate the lane change reference line 303 by vertically extending a straight line from the central point of the front (e.g., bumper) of the vehicle 10 and extending it in parallel with the central line 306 of the driving lane.

The lane change control device 100 generates a driving direction reference line 304 in the driving direction of the vehicle 10 (S103), and is configured to determine an angle between the lane change reference line 303 and the driving direction reference line 304 (S104).

Next, the lane change control apparatus 100 is configured to determine a movement amount of the lane change reference line for correcting turning of the vehicle 10 by use of the angle between the determined lane change reference line 303 and the driving direction reference line 304, and generate the moved lane change reference line 305 by moving the lane change reference line 303 (S105). In the instant case, the lane change control apparatus 100 may be configured to determine the movement amount of the lane change reference line by applying the determined angle between the lane change reference line 303 and the driving direction reference line 304 to a trigonometric function.

Next, the lane change control apparatus 100 may be configured to determine the lane change start point 312 at which the turning of the vehicle 10 may be corrected by use of the angle between the determined lane change reference line 303 and the driving direction reference line 304, and determine the lane change end point 314 to generate the new lane change path 302 again (S106). In the instant case, the lane change control apparatus 100 may be configured to determine the lane change start point 312 by use of a vehicle speed and a control target time, the trigonometric function, and the angle between the lane change reference line 303 and the driving direction reference line 304 as in Equation 2 above.

Subsequently, the lane change control apparatus 100 may be configured to determine a length of a final lane change path by determining the lane change end point 314 as shown in Equation 3.

Accordingly, the lane change control apparatus 100 may be configured for controlling the lane change to be performed by following the new lane change path 302.

Accordingly, according to an exemplary embodiment of the present disclosure, in response to trying to perform the lane change again while returning to the original lane after the lane change was canceled, even in a state where the vehicle has not completely returned to the original lane, it is possible to generate a new lane change path based on the current position of the vehicle, reducing a lane change time.

Furthermore, according to an exemplary embodiment of the present disclosure, it is possible to increase vehicle driving safety by enabling rapid response to changes in surrounding situations, such as a change in speed of an object behind the target lane during a lane change.

Furthermore, in a state of trying to perform lane change again while returning to an original lane after the lane change is canceled, that is, in a state where the vehicle does not completely return to the original lane and attempts to perform the lane change again while returning, it is very likely that the vehicle is turned, but according to an exemplary embodiment of the present disclosure, it is possible to natural behavior of the vehicle during the lane change by generating a new lane change path by reflecting the turning of the vehicle.

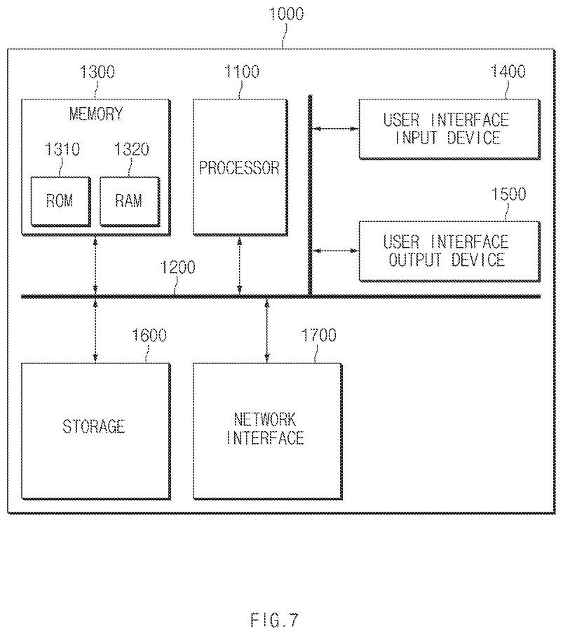

FIG. 7 illustrates an example computing system.

Referring to FIG. 7, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that is configured to perform processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A lane change control apparatus comprising:
a processor configured to generate a second lane change path according to a head angle of a vehicle at a current position of the vehicle to try lane change again in response that the lane change is canceled while the vehicle is performing the lane change according to a first lane change path and then the cancellation of the lane change is withdrawn while the vehicle is returning to an original lane of the vehicle; and
a storage configured to store data and algorithms driven by the processor.

2. The lane change control apparatus of claim 1, wherein, for generation of the second lane change path, the processor is further configured to generate a lane change reference line as a reference for the vehicle to perform the lane change, and to generate a driving direction reference line extending in a driving direction of the vehicle.

3. The lane change control apparatus of claim 2, wherein the processor is further configured to generate the lane change reference line as a straight line extending from a front center portion of the vehicle, to allow the lane change reference line to be in parallel to a central line of a driving lane in which the vehicle is driving.

4. The lane change control apparatus of claim 2, wherein the processor is further configured to determine an angle between the lane change reference line and the driving direction reference line.

5. The lane change control apparatus of claim 2, wherein the processor is further configured to correct the lane change reference line according to the head angle of the vehicle.

6. The lane change control apparatus of claim 2, wherein the processor is further configured to move the lane change reference line in a direction of a target lane, which is a target for the lane change, or in a direction of a driving lane in which the vehicle is currently driving by use of an angle between the lane change reference line and the driving direction reference line.

7. The lane change control apparatus of claim 2, wherein the processor is further configured to determine a movement amount of the lane change reference line using at least one of a distance from a central line of a driving lane to the lane change reference line, an angle between the lane change reference line and the driving direction reference line, or a combination thereof.

8. The lane change control apparatus of claim 2, wherein the processor is further configured to determine a movement amount of the lane change reference line by applying an angle between the lane change reference line and the driving direction reference line to a function.

9. The lane change control apparatus of claim 2, wherein the processor is further configured, in response to a case of moving the lane change reference line in a direction of a target lane, to prevent the lane change reference line from encroaching on a lane next to the target lane.

10. The lane change control apparatus of claim 2, wherein the processor is further configured, in response to a case of moving the lane change reference line in a direction of a driving lane, to prevent the lane change reference line from encroaching on a central line of the driving lane.

11. The lane change control apparatus of claim 2, wherein the processor is further configured to determine a lane change start point, which is a start point for the lane change by use of at least one of a speed of the vehicle, a control target time, an angle between the lane change reference line and the driving direction reference line, or a combination thereof.

12. The lane change control apparatus of claim 2, wherein the processor is further configured to determine a lane change start point by applying an angle between the lane change reference line and the driving direction reference line to a function.

13. The lane change control apparatus of claim 10, wherein the processor is further configured to determine a lane change start point to be positioned on the moved lane change reference line.

14. The lane change control apparatus of claim 2, wherein the processor is further configured to determine a lane change end point, which is a point at which the lane change is completed, by use of a speed of the vehicle and a time required for the lane change to be completed from a lane change start point.

15. The lane change control apparatus of claim 14, wherein the processor is further configured to determine a lane change intermediate point between the lane change start point and the lane change end point according to a distance ratio predetermined by a user.

16. The lane change control apparatus of claim 2, wherein a movement amount of the lane change reference line increase and a driving distance for the lane change increase as an angle between the lane change reference line and the driving direction reference line increases.

17. The lane change control apparatus of claim 2,
wherein a return path includes a start point, an intermediate point, and an end point, and
wherein, in response that the vehicle follows the return path to the original lane and returns to the original lane, the processor is further configured to move the lane change reference line in a direction of a target lane, in a state where the cancellation of the lane change is withdrawn at the start point and a head of the vehicle is directed in the direction of the target lane, which is a target for the lane change.

18. The lane change control apparatus of claim 2,
wherein a return path includes a start point, an intermediate point, and an end point, and
wherein, in response that the vehicle follows the return path to the original lane and returns to the original lane, the processor is further configured to move the lane change reference line in a direction of the original lane, in a state where the cancellation of the lane change is withdrawn at the intermediate point and a head of the vehicle is directed in the direction of the original lane.

19. A lane change control method comprising:
canceling, by a processor, a lane change while a vehicle is performing the lane change along a first lane change path;
withdrawing, by the processor, cancellation of the lane change while the vehicle is returning to an original lane of the vehicle; and
generating, by the processor, a second lane change path according to a head angle of the vehicle from a current position of the vehicle to attempt the lane change again.

20. The lane change control method of claim 19, wherein the generating of the second lane change path includes:
generating, by the processor, a lane change reference line as a reference for the vehicle to perform the lane change, and generating a driving direction reference line extending in a driving direction of the vehicle, for generation of the second lane change path; and
moving the lane change reference line in a direction of a target lane, which is a target for the lane change, or in a direction of a driving lane in which the vehicle is currently driving by use of an angle between the lane change reference line and the driving direction reference line.
